(19) United States
(12) Patent Application Publication
(10) Pub. No.: US 2018/0118231 A1
(43) Pub. Date: May 3, 2018

(54) COMMODITY MEASURING FOR A RAILCAR

(71) Applicant: Trinity North American Freight Car, Inc., Dallas, TX (US)

(72) Inventor: Kenneth W. Huck, Fairview, TX (US)

(21) Appl. No.: 15/337,820

(22) Filed: Oct. 28, 2016

(51) Int. Cl. B61D 49/00; B61D 7/02; G01N 27/22; G01N 21/90; G01N 27/24

(52) U.S. Cl. CPC B61D 49/00; B61D 7/02; B61D 39/001; G01N 21/9072; G01N 27/24; G01N 27/223

(57) ABSTRACT

According to some embodiments, a system for determining a characteristic of a bulk lading of a railcar comprises a sensor (e.g., infrared, radio, electrical, optical, etc.) operable to determine a characteristic of a bulk lading; a controller communicably coupled to the sensor and configured to control sensor operations; and a display communicably coupled to the sensor and configured to display a representation of the determined characteristic of the bulk lading. In particular embodiments, the sensor may detect a moisture content of the bulk lading or a foreign substance in the bulk lading. At least one of the sensor, the controller, and the display may comprise a power source. At least one of the controller and the display may be wirelessly coupled to the sensor.

### TECHNICAL FIELD OF THE INVENTION

This disclosure generally relates to railcars, and more particularly to commodity measuring for railcars, such as hopper, pressure differential, and gondola railcars, for example.

### BACKGROUND

Railway hopper cars transport and sometimes store bulk materials. Hopper cars generally include one or more hoppers which may hold cargo or lading during shipment. Hopper cars are frequently used to transport coal, sand, metal ores, aggregates, grain, plastic pellets, and any other type of lading which may be satisfactorily discharged through openings formed in one or more hoppers. Discharge openings are typically provided at or near the bottom of each hopper to rapidly discharge cargo. A variety of door assemblies or gate assemblies along with various operating mechanisms have been used to open and close discharge openings associated with railway hopper cars.

Transversely oriented discharge openings and gates are frequently coupled with a common linkage operated by an air cylinder. The air cylinder is typically mounted in the same orientation as the operating gate linkage which is often a longitudinal direction relative to the associated hopper.

Longitudinally oriented discharge openings and doors are often used in pairs that may be rotated or pivoted relative to the center sill or side sills of a hopper car. Longitudinally oriented discharge openings and doors may be coupled with a beam operated by an air cylinder. The air cylinder is typically mounted in the same orientation as the operating beam which is often a longitudinal direction relative to the associated hopper. The operating beam may be coupled to the discharge doors by door struts that push (or pull) the gates open or pull (or push) them closed as the air cylinder moves the operating beam back and forth.

Hopper cars may be classified as open or closed. Hopper cars may have relatively short sidewalls and end walls or relatively tall or high sidewalls and end walls. The sidewalls and end walls of many hopper cars are often formed from steel or aluminum sheets and reinforced with a plurality of vertical side stakes or support posts. Some hopper cars include interior frame structures or braces to provide additional support for the sidewalls.

Pressure differential hopper cars may use regulated air pressure and airtight covers to facilitate quick unloading of fine, dry products, such as agricultural and food products (e.g., flour, grain meals, starch, etc.) and chemical or processed mineral products (e.g., ashes, calcium carbonite, cement, clay, gypsum, lime, etc.). Gondola railcars typically have an open top and low walls and transport high-density bulk materials (e.g., coal, steel, etc.).

### SUMMARY OF THE INVENTION

Particular embodiments described herein include system for determining characteristics of a lading of a railcar, such as hopper or gondola railcars. According to some embodiments, a railcar comprises a container for transporting a bulk lading; a sensor operable to determine a characteristic of the bulk lading; a controller communicably coupled to the sensor and configured to control operation of the sensor; and a display communicably coupled to the sensor and configured to display a representation of the determined characteristic of the bulk lading.

In particular embodiments, the sensor is located in an interior portion of the container. The container may comprise a discharge gate. The sensor may be located proximate the discharge gate and may be operable to determine the characteristic of the bulk lading as the bulk lading is discharged through the discharge gate. The sensor may be located proximate a top of the container and may be operable to determine the characteristic of the bulk lading as the bulk lading is loaded into the container.

In particular embodiments, the sensor is located on an exterior portion of the container. The container may comprise a window. The sensor may be operable to determine the characteristic of the bulk lading through the window.

In particular embodiments, the sensor comprises at least one of a near infrared reflectance (NIR) sensor, a radio frequency (RF) sensor, an electrical capacitance (EC) sensor, a camera, a photometer, a charged coupled device, and a laser sensor. The sensor may determine, for example, a moisture content of the bulk lading or an indication of a foreign substance in the bulk lading. The foreign substance may comprise mold or fungus. The foreign substance may comprise a plastic pellet of a different color than an intended lading of plastic pellets.

In particular embodiments, at least one of the sensor, the controller, and the display comprise a power source. At least one of the controller and the display may be communicably coupled to the sensor wirelessly.

According to some embodiments, a system for determining a characteristic of a bulk lading of a railcar comprises a sensor operable to determine a characteristic of a bulk lading; a controller communicably coupled to the sensor and configured to control sensor operations; and a display communicably coupled to the sensor and configured to display a representation of the determined characteristic of the bulk lading.

In particular embodiments, the sensor is operable to determine the characteristic of the bulk lading as the bulk lading is discharged from the railcar. In particular embodiments, the sensor may be operable to determine the characteristic of the bulk lading as the bulk lading is loaded into the railcar

In particular embodiments, the sensor comprises at least one of a near infrared reflectance (NIR) sensor, a radio frequency (RF) sensor, an electrical capacitance (EC) sensor, a camera, a photometer, a charged coupled device, and a laser sensor. The sensor may determine, for example, a moisture content of the bulk lading or an indication of a foreign substance in the bulk lading. The foreign substance may comprise mold or fungus. The foreign substance may comprise a plastic pellet of a different color than an intended lading of plastic pellets.

In particular embodiments, at least one of the sensor, the controller, and the display comprise a power source. At least one of the controller and the display may be communicably coupled to the sensor wirelessly.

As a result, particular embodiments of the present disclosure may provide numerous technical advantages. For example, particular embodiments may measure the quality or other properties (moisture content, quantity of defects, etc.) of the lading as the lading is loaded, unloaded, or in transit. Particular embodiments facilitate measurement when the railcar is stationary or in transit. By providing commodity measurements in real time, trains do not have to be stopped to collect commodity samples prior to unloading.

The intended receiver of the lading (i.e., the end purchaser) may verify that the product is what was expected when ordered. The receiver can determine whether to adjust downstream processing depending on the measurement results. For example, a receiver may make modifications to a grain processing facility based on a moisture content of the received grain in advance of receiving the grain.

Detecting fungus or mold within a commodity could prevent contamination within a receiver's processing system by alerting the receiver before unloading the lading. Detecting sub-par commodities or rejectable commodities after loading or during transport may reduce shipping costs by identifying problems early and circumventing unnecessary shipment.

Measuring product consistency, quality, and other properties in real time can optimize the efficiency of downstream processing. Advantages may include: measuring product consistency (identifying defects); reducing energy costs by optimizing processing; increasing downstream product quality; reducing downstream resource requirements; increasing productivity and profitability; and reducing waste and time. Particular embodiments of the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1 is a schematic drawing in elevation showing a side view of an example hopper car, according to some embodiments;

FIG. 2 is a schematic drawing in elevation showing an end view of an example hopper car, according to some embodiments;

FIG. 3A is a schematic drawing in elevation of a cross-section of an example hopper car with a commodity sensor, according to a particular embodiment;

FIG. 3B is a schematic drawing in elevation of a cross-section of an example hopper car with a lading flowing around a commodity sensor, according to a particular embodiment;

FIG. 4 is a schematic drawing in isometric view of a cross-section of an example hopper car with a commodity sensor, according to a particular embodiment;

FIG. 5 is a schematic drawing in elevation of a cross-section of another example hopper car with a commodity sensor, according to a particular embodiment;

FIG. 6 is a schematic drawing in elevation of a cross-section of an example covered hopper car with a commodity sensor mounted on the hopper cover; and

FIG. 7 is block diagram illustrating an example system for determining a characteristic of a bulk lading of a railcar.

### DETAILED DESCRIPTION

Particular embodiments include commodity measurements in railcars, such as hopper, pressure differential, and gondola railcars. The quality of delivered products is important for the receiving party to determine if they are getting what they paid for and to help them adjust downstream processing to account for variances. For example, corn or soybean moisture content may affect their price. For example, too much or too little moisture may change the value.

As another example, if a grain is too dry, excessive losses may be incurred because of breakage. If the moisture content is too high, additional expense may be incurred to remove moisture through drying. Depending upon the end-use of the grain, knowing its moisture content may affect the grain's value and may change how the product is handled and processed in order to optimize efficiency.

Other properties may also be important, depending upon the commodity being transported in the railcar. Grains, sand, potash, phosphate, and plastics are example commodities where particular property or characteristic measurements may be beneficial.

Currently, monitoring a railcar's lading relies on manual inspection. For example, when the railcar is stopped, an operator wearing a safety harness and other safety equipment (protective suit, etc.) may climb to the top of the railcar, open the railcar's hatch, and insert a measuring device into the railcar's hopper or tank. Sometimes the operator may collect a commodity sample and take it to a lab for processing. This can be costly and time consuming. Particular embodiments described herein make measuring commodity characteristics faster, safer, and less expensive.

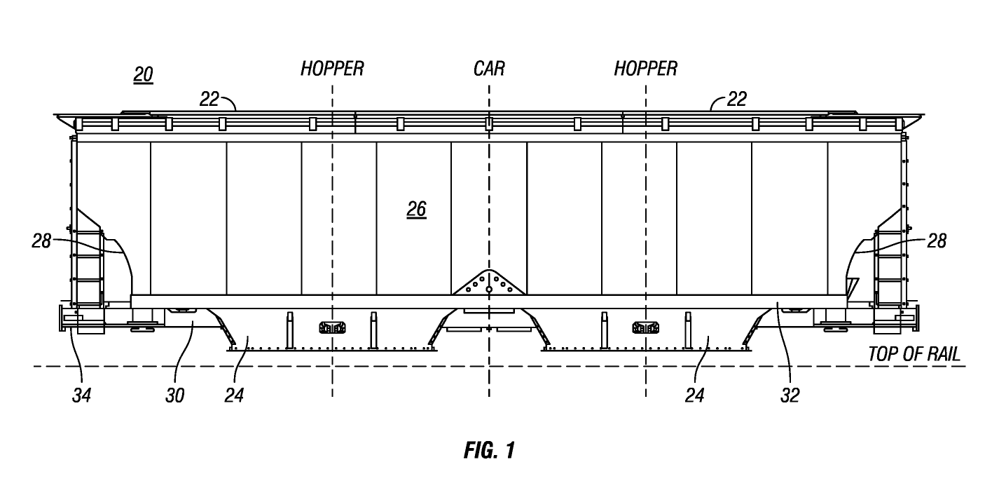

Particular embodiments obviate the problems described above and include a system for determining a characteristic of a bulk lading of a railcar. The system comprises a sensor operable to determine a characteristic of a bulk lading; a controller communicably coupled to the sensor and configured to control sensor operations; and a display communicably coupled to the sensor and configured to display a representation of the determined characteristic of the bulk lading. Depending on the lading, particular sensors may include food grade analyzers. Other embodiments and ladings may use explosion proof sensors. Particular embodiments of the invention and its advantages are best understood by reference to FIGS. 1 through 7, wherein like reference numbers indicate like features.

FIG. 1 is a schematic drawing in elevation showing a side view of an example hopper car, according to a particular embodiment. Hopper car 20 may carry bulk materials such as coal and other types of lading. Examples of such lading may include sand, metal ores, aggregate, grain, ballast, etc.

Hopper car 20 may be generally described as a covered hopper car. However, other embodiments may include open hopper cars or any other cars (e.g., gondola cars) suitable for carrying bulk lading. Hopper car 20 includes containers for transporting its lading, such as hoppers 22 with bottom discharge assemblies 24. Discharge assemblies 24 may be opened and closed to control discharge of lading from hoppers 22. As illustrated, hopper car 20 includes two hoppers 22. In other embodiments, hopper car 20 may include one, two, three, or any suitable number of hoppers 22. Particular embodiments may include other containers for transporting lading, with or without discharge assemblies.

In particular embodiments, hopper 22 is configured to carry bulk materials and the interior walls of hopper 22 are generally sloped towards discharge assembly 24 to facilitate discharge of the lading. Multiple hoppers 22 may be separated by interior bulkheads.

In particular embodiments, hopper car 20 may include a pair of sidewall assemblies 26 and sloped end wall assemblies 28 mounted on a railway car underframe. The railway car underframe includes center sill 34 and a pair of shear plates 32. The pair of sill plates 32 provide support for sidewall assemblies 26.

Center sill 34 is a structural element for carrying the loads of the hopper car. Center sill 34 transfers the various longitudinal forces encountered during train operation from car to car. Shear plates 30 extend generally parallel with center sill 34 and are spaced laterally from opposite sides of center sill 34.

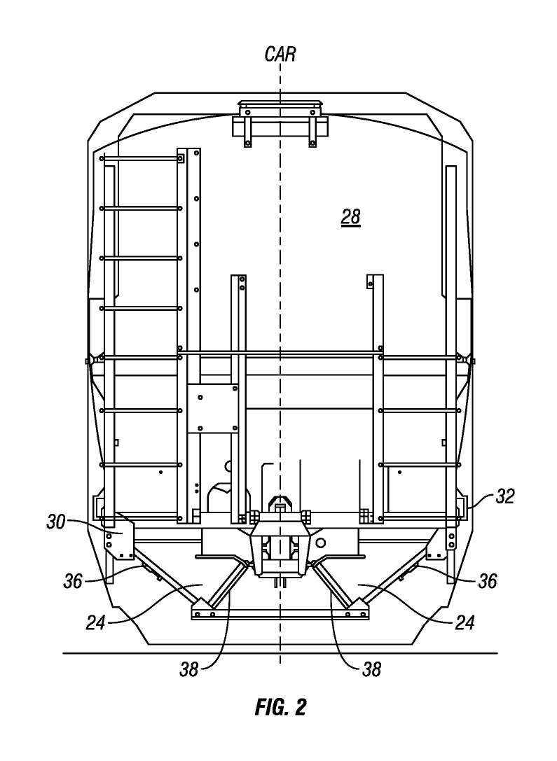

FIG. 2 is a schematic drawing in elevation showing an end view of an example hopper car, according to a particular embodiment. FIG. 2 illustrates discharge assemblies 24, end wall assemblies 28, shear plates 30, and sill plates 32 of hopper car 20 illustrated in FIG. 1.

Discharge assembly 24 comprises slope sheet 36 and discharge door 38. Slope sheet 36 slopes from sidewall assembly 26 towards the center of hopper car 20 to facilitate discharge of the lading from the discharge opening of discharge assembly 24 when discharge door 38 is open.

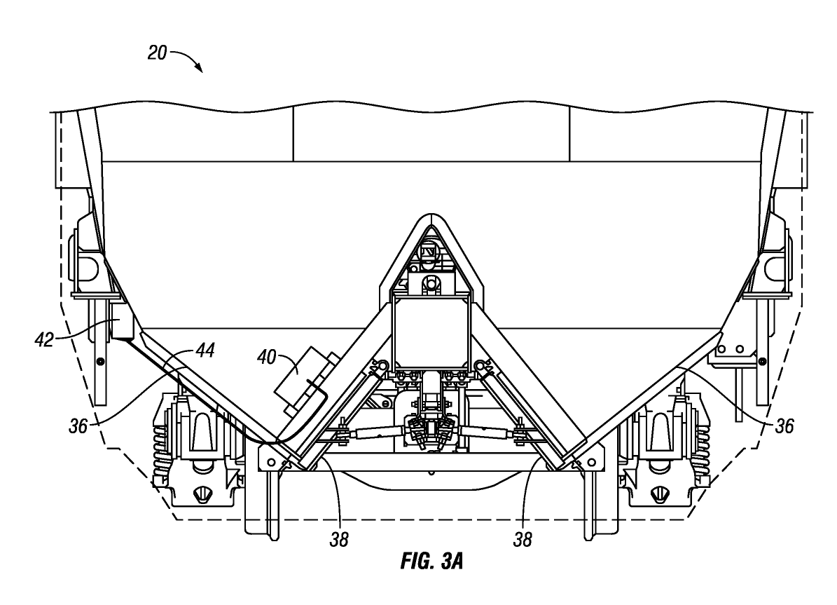

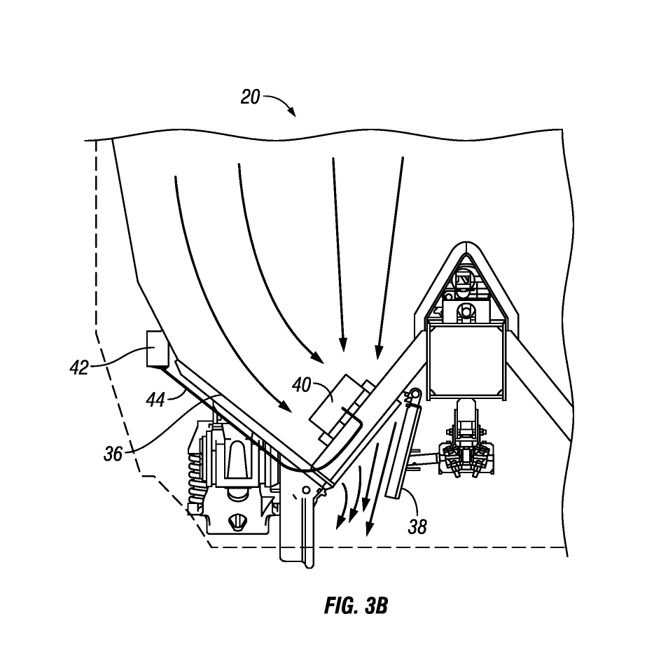

For particular commodities, such as corn, soybeans, sand, etc., moisture content may be important. Particular embodiments include a moisture sensor installed on a discharge gate of a railcar. When the discharge gates are open, product flows through and/or around the moisture sensor, which measures the moisture content of the commodity. An example is illustrated in FIG. 3A.

FIG. 3A is a schematic drawing in elevation of a cross-section of an example hopper car with a commodity sensor, according to a particular embodiment. FIG. 3A illustrates a railcar, such as railcar 20, with slope sheet 36 and discharge door 38 as described with respect to FIG. 2. Although a particular type of railcar is illustrated, other embodiments may include any type of railcar suitable for transporting bulk lading (e.g., hopper car, pressure differential car, gondola car, tank car, etc.).

Railcar 20 also includes sensor 40, control and display 42, and wiring harness 44. When discharge door 38 is open, commodity (bulk lading) flows through (or over, around, etc.) sensor 40 (see FIG. 3B).

Sensor 40 determines a characteristic of the bulk lading of railcar 20. In particular embodiments, sensor 40 comprises a Near Infrared Reflectance (NIR), a Radio Frequency (RF), an Electrical Capacitance (EC), or any other type of sensor suitable for measuring a characteristic of the bulk lading commodity. Other types of sensors are described in more detail below.

Control and display 42 controls sensor 40 and displays the results of measurements performed by sensor 40. For example, control and display 42 may include buttons, switches, etc. for activating or deactivating the measurement functions of sensor 40. Control and display 42 may include lights, LEDs, meters, gauges, graphical displays, and/or any other suitable (analog or digital) display of the results of measurements performed by sensor 40.

Wiring harness 44 communicably couples control and display 42 to sensor 40. Wiring harness 44 may communicate control information from control and display 42 to sensor 40 and may communicate output information from sensor 40 to control and display 42 for display to an operator.

In particular embodiments, wiring harness 44 may also provide power to sensor 40. For example, control and display 42 may include a connection to facility power. When the railcar is in the rail yard, an operator may connect the railcar to facility power. Wiring harness 44 may transmit power from control and display 42 to sensor 40.

In some embodiments, control and display 42 may include a battery. Wiring harness 44 may transmit power from control and display 42 to sensor 40. In some embodiments, sensor 40 may include a battery. Wiring harness 44 may transmit power from sensor 40 to control and display 42. In some embodiments, both control and display 42 and sensor 40 may include batteries.

Some embodiments may not include wiring harness 44. For example, sensor 40 and control and display 42 may communicate wirelessly (e.g., WiFi, machine-to-machine cellular communications, bluetooth, point-to-point radio links, etc.). One or both of sensor 40 and control and display 42 may be battery powered, facility powered, or any combination of battery and facility powered.

Although control and display 42 is illustrated as a single unit, other embodiments may include separate display and control units. In some embodiments, sensor 40 may include a controller. For example, sensor 40 may include a controller that automatically activates sensor 40 when discharge door 38 is open and deactivates sensor 40 when discharge door 38 is closed. In some embodiments, the controller may include a motion sensor that automatically activates sensor 40 when the controller senses motion of the bulk lading commodity. The controller may deactivate sensor 40 when the controller senses motion of the bulk lading commodity has stopped or after a predetermined amount of time.

In some embodiments, one or both of the control and the display may be located remotely from railcar 20. Sensor 40 may be activated remotely, which enables the lading the monitored at any desired time, such as during transit or in the rail yard. A remote display may enable remote viewing of the data collected from sensor 40. Particular embodiments may include both local (i.e., located with the railcar) and remote control and/or display units.

Particular embodiments may not have a display. Particular embodiments may store measurement results in a memory, which may be downloaded at a later time. For example, measurement results may be stored on a removable storage media, or in a memory accessible over a network, accessible locally via a cable, wirelessly, etc.

FIG. 3B is a schematic drawing in elevation of a cross-section of an example hopper car with a lading flowing around a commodity sensor, according to a particular embodiment. FIG. 3B illustrates a railcar, such as railcar 20, with the same components as described with respect to FIG. 3A. In the illustrated embodiment, discharge door 38 is open.

When discharge door 38 is open, the commodity in railcar 20 may flow (represented by the illustrated arrows) through, over, and/or around sensor 40 (depending on the type of sensor) as the commodity discharges from railcar 20. In particular embodiments, sensor 40 may activate by automatically detecting movement of the commodity, by automatically detecting movement of the door, and/or by receiving an activation command from control and display 42.

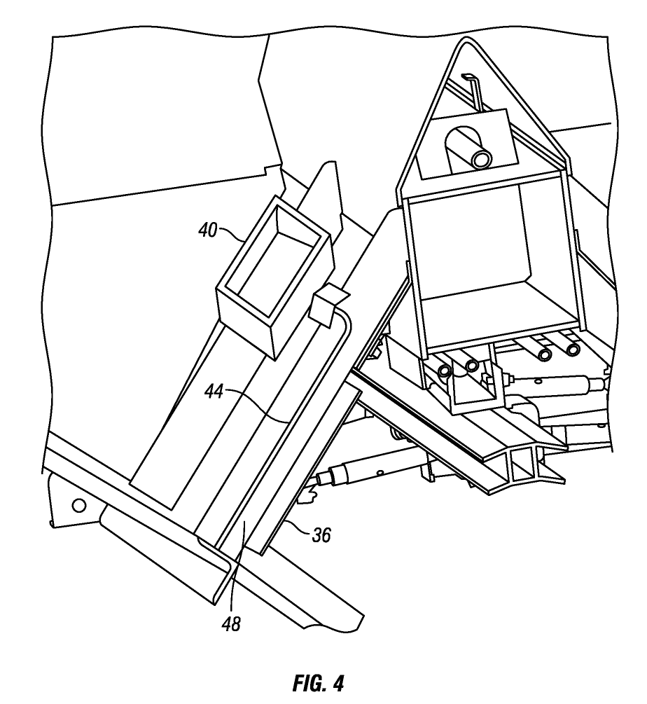

FIG. 4 is a schematic drawing in isometric view of a cross-section of an example hopper car with a commodity sensor, according to a particular embodiment. Sensor 40 and wiring harness 44 are similar to those described with respect to FIGS. 3A and 3B.

Sensor 40 and wiring harness 44 are attached to support member 48. Support member 48 provides support for discharge door 38. Attaching sensor 40 and wiring harness 44 to support member 48 protects sensor 40 and wiring harness 44 from the movement of discharge door 38, but still locates sensor 40 proximate discharge door 38. An advantage of locating sensor 40 proximate discharge door 38 is to maximize the amount of lading sensor 40 may monitor as the lading is discharged. Although a hopper car with longitudinal discharge gates is illustrated, other embodiments may include transverse discharge gates or any other suitable discharge gate for the particular lading.

In some embodiments sensor 40 may comprise a wireless sensor. Wireless sensor 40 may be located in any suitable location near the discharge opening, including on discharge door 38.

Particular embodiments may include any suitable number of sensors 40 located at any suitable location on or within railcar 20. In some embodiments, one or more sensors 40 may be located near the hatch area at the top of railcar 20. Sensor 40 may measure the characteristics of the commodity as the commodity is loaded into the railcar.

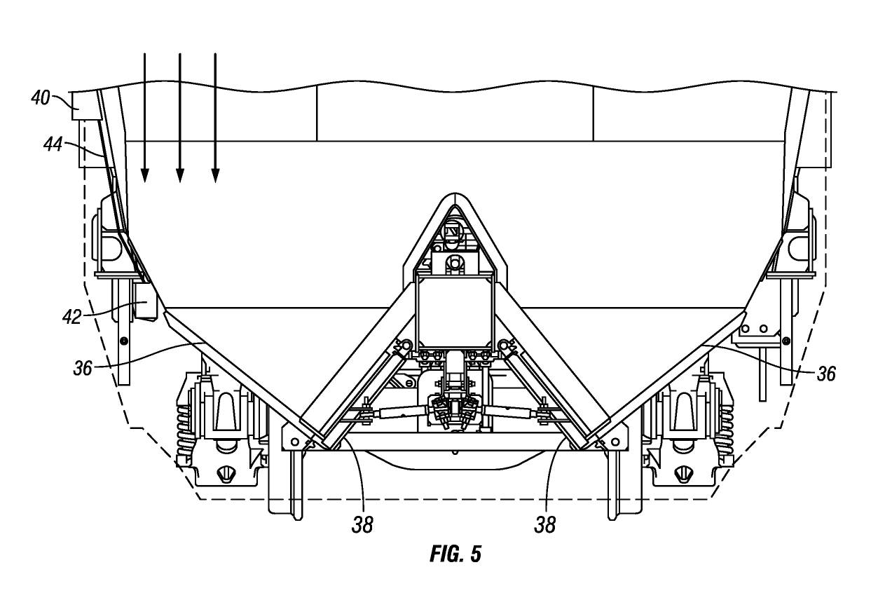

Particular embodiments may include visual sensors to measure characteristics of the commodity. For example, sensor 40 may comprise one or more cameras, photometers, charged coupled devices, lasers, or other light sensing components suitable for measuring the contents of a railcar. An example is illustrated in FIG. 5.

FIG. 5 is a schematic drawing in elevation of a cross-section of another example hopper car with a commodity sensor, according to a particular embodiment. Sensor 40 is located on the outside of railcar 20. In particular embodiments, sensor 40 may visually inspect the contents of railcar 20 through a window or any other suitable opening in railcar 20. One or more sensor 40 may be located at any suitable height (e.g., near the bottom, near the middle, near to the top, or any combination of locations) along the outside wall of railcar 20. In particular embodiments, sensor 40 may inspect the commodity as the commodity is being loaded (arrows in illustration) into railcar 20.

In some embodiments, sensor 40 may be embedded within the walls of railcar 20, or located on an inside wall of railcar 20. Wiring harness 44 may pass through the wall to connect sensor 40 to control and display 42.

As a particular example, sensor 40 may include a camera and flash that records an image of soybeans passing a clear window in railcar 20. A controller may analyze the data to determine a percentage of split beans. The percentage of split beans may be communicated to and displayed on control and display 42. The monitoring may occur continuously or in rapid succession throughout the loading or unloading process to determine the quality of the product.

In some embodiments, the sensor 40 may identify foreign material within the lading. For example, for a railcar transporting plastic pellets, sensor 40 may measure or detect unwanted color pellets that may be contaminating a shipment.

In some embodiments, sensor 40 may identify foreign material within the railcar prior to loading a commodity. For example, any residual plastic pellets remaining in a railcar from a shipment of red plastic pellets could contaminate a shipment of white plastic pellets. Sensor 40 may visually detect the presence of residual pellets in railcar 20 before a lading is loaded into railcar 20.

When shipping grains, the presence of molds or fungi may affect the quality of the product. In some embodiments, sensor 40 samples the air as the product is loaded, unloaded, or while the railcar is stationary or during transport. Sensor 40 draws air from the railcar to measure mold or fungi spores and reports the information to control and display 42.

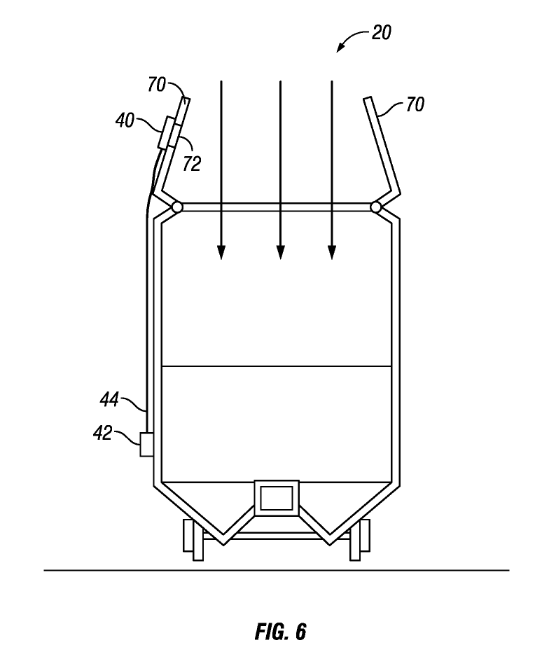

A particular advantage of some embodiments is that the quality of the product can be continually monitored throughout the shipping process, from loading, storage, transport, and unloading. If an end-user knows the characteristics of a particular shipment before the shipment is unloaded, the end-user may reject the load before unloading (saving the cost of unloading and reloading for return shipment), or the end-user may prepare for special processing (e.g., moisture removal) when the shipment arrives. FIG. 6 illustrates another example commodity sensor.

FIG. 6 is a schematic drawing in elevation of a cross-section of an example covered hopper car with a commodity sensor mounted on the hopper cover. Railcar 20 includes hopper covers 70. Hopper covers 70 are closed during transport to protect the lading of railcar 20. Hopper covers 70 are open during loading to facilitate access to the hoppers of railcar 20.

In some embodiments, sensor 40 similar to sensor 40 described with respect to FIG. 5 is located outside or embedded in hopper cover 70. Hopper cover 70 may comprise window 72. Sensor 40 may sense the In particular embodiments sensor 40 may be located on the inside of hopper cover 70.

In particular embodiments, hopper cover 70 may be open to facilitate loading of a commodity and sensor 40 may visually inspect the commodity as it is loaded into railcar 20 through window 72 or any other suitable opening in hopper cover 70. When hopper cover 70 is in the open position, sensor 40 pointed horizontally and is well-positioned to monitor and/or measure the commodity as it is loaded (arrows in illustration) into railcar 20. For example, sensor 40 may include a camera and flash that records an image of plastic pellets being loaded into railcar 20.

When hopper cover 70 is in the closed position, sensor 40 is pointed down and is well-positioned to monitor and/or measure the contents of railcar 20. For example, sensor 40 may monitor the inside of railcar 20 for any off-color residual plastic pellets remaining in railcar 20 from a previous shipment that could contaminate a current shipment before the current shipment of plastics pellets is loaded into the railcar.

A particular advantage is that sensor 40 may monitor different characteristics of a lading depending on the position of hopper covers 70. Some embodiments may include any suitable number of sensors 40.

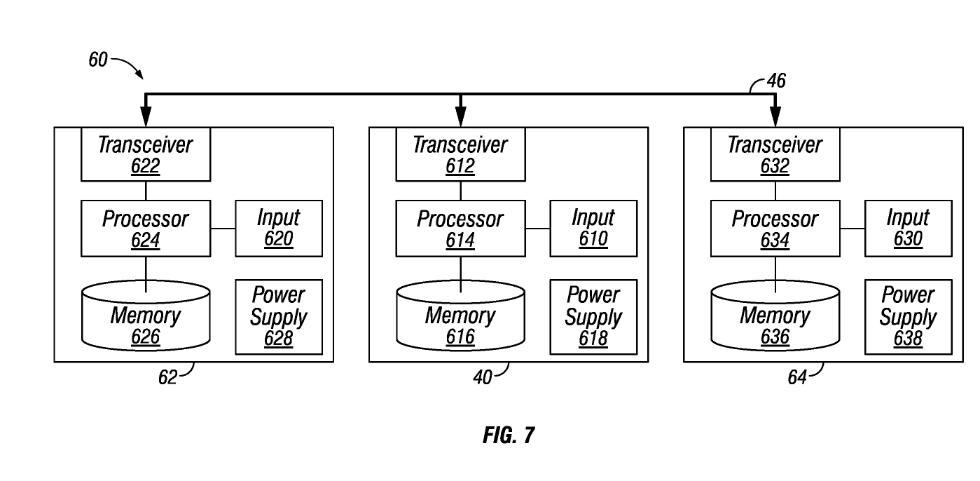

FIG. 7 is block diagram illustrating an example system for determining a characteristic of a bulk lading of a railcar. System 60 includes sensor 40, controller 62, and display 64. Sensor 40 may optionally be coupled to controller 62 and display 64 via one or more wiring harnesses 46. In other embodiments, sensor 40 may be wirelessly coupled to controller 62 and display 64. Sensor 40 receives control information from controller 62 and sends data to display 64.

Sensor 40 is an example of sensors 40 illustrated in FIGS. 3-6. Sensor 40 is operable to determine a characteristic of a bulk lading of a railcar, such as railcar 20. Sensor 40 includes detector 610, transceiver 612, processor 614, memory 616, and optional power supply 618.

Examples of detector 610 include a Near Infrared Reflectance (NIR) sensor, Radio Frequency (RF) sensor, Electrical Capacitance (EC) sensor, camera, photometer, charged coupled device, laser, or any other components suitable for measuring, monitoring, or detecting the contents of a railcar.

In some embodiments, transceiver 612 facilitates transmitting wired/wireless signals to and receiving wired/wireless signals from controller 62 and display 64. Processor 614 executes instructions to provide some or all of the functionality described herein as provided by sensor 40, and memory 616 stores the instructions executed by processor 614. Optional power supply 618 supplies electrical power to one or more of the components of sensor 40.

Processor 614 includes any suitable combination of hardware and software implemented in one or more integrated circuits or modules to execute instructions and manipulate data to perform some or all of the described functions of sensor 40. In some embodiments, processor 614 may include, for example, one or more computers, one more programmable logic devices, one or more central processing units (CPUs), one or more microprocessors, one or more applications, and/or other logic, and/or any suitable combination of the preceding. Processor 614 may include analog and/or digital circuitry configured to perform some or all of the described functions of sensor 40. For example, processor 614 may include resistors, capacitors, inductors, transistors, diodes, and/or any other suitable circuit components.

Memory 616 is generally operable to store computer executable code and data. Examples of memory 616 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

Optional power supply 618 is generally operable to supply electrical power to the components of sensor 40. Power supply 618 may include any suitable type of battery, such as alkaline, lithium-ion, lithium-air, lithium polymer, nickel cadmium, nickel metal hydride, or any other suitable type of battery for supplying power to a sensor.

In particular embodiments, processor 614 in communication with transceiver 612 transmits data obtained data from detector 610 to display 64 and receives instructions, commands, or other control information from controller 62. Other embodiments of sensor 40 may include additional components (beyond those shown in FIG. 6) responsible for providing certain aspects of the sensor's functionality, including any of the functionality described above and/or any additional functionality (including any functionality necessary to support the solution described above).

Controller 62 is an example of the control portion of control and display 42 illustrated in FIGS. 3-5. Controller 62 is operable to control a sensor, such as sensor 40. Controller 62 includes input 620, transceiver 622, processor 624, memory 626, and optional power supply 628.

Input 610 receives input to activate, deactivate, calibrate or control any other function of sensor 40. In some embodiments, input 610 may comprise buttons, dials, switches, keypad, touchscreen, or any other suitable analog or digital input for a rail operator to manually control sensor 40. In some embodiments, input 610 may receive signals from other systems of railcar 20. For example, input 610 may receive a signal to open a discharge gate of railcar 20 and may automatically activate sensor 40 based on the received signal. In some embodiments, input 610 may receive wireless input from a remote operator.

In some embodiments, transceiver 622 facilitates transmitting wired/wireless signals to and receiving wired/wireless signals from sensor 40 and/or display 64. Processor 624 executes instructions to provide some or all of the functionality described herein as provided by controller 62, and memory 626 stores the instructions executed by processor 624. Optional power supply 628 supplies electrical power to one or more of the components of controller 62. Processor 624, memory 626, and power supply 628 can be of the same types as described with respect to processor 614, memory 616, and power supply 618 described above with respect to sensor 40. In particular embodiments, sensor 40 may include controller 62.

In particular embodiments, processor 624 in communication with transceiver 622 transmits control information to sensor 40. Other embodiments of controller 62 may include additional components (beyond those shown in FIG. 6) responsible for providing certain aspects of the controller's functionality, including any of the functionality described above and/or any additional functionality (including any functionality necessary to support the solution described above).

Display 64 is an example of the display portion of control and display 42 illustrated in FIGS. 3-5. Display 64 operable to display data determined by a sensor, such as sensor 40. Display 64 includes output 630, transceiver 632, processor 634, memory 636, and optional power supply 638.

Output 630 displays data determined by sensor 40. In some embodiments, output 630 may comprise lights, gauges, meters, graphic display screen, touchscreen, etc.

In some embodiments, transceiver 632 facilitates receiving wired/wireless signals from sensor 40 and/or control 62. Processor 634 executes instructions to provide some or all of the functionality described herein as provided by display 64, and memory 636 stores the instructions executed by processor 634. Optional power supply 638 supplies electrical power to one or more of the components of display 64. Processor 634, memory 636, and power supply 638 can be of the same types as described with respect to processor 614, memory 616, and power supply 618 described above with respect to sensor 40. In particular embodiments, display 64 may include controller 62 or controller 62 may include display 64.

In particular embodiments, processor 634 in communication with transceiver 632 transmits receives data from sensor 40. Other embodiments of display 64 may include additional components (beyond those shown in FIG. 6) responsible for providing certain aspects of the controller's functionality, including any of the functionality described above and/or any additional functionality (including any functionality necessary to support the solution described above).

The example embodiments described herein may be included with a new railcar. In some embodiments, the components described herein may be retrofitted to existing railcars.

Although the embodiments in the illustrated examples included hopper cars, other embodiments may include other railcars. For example, in some embodiments the railcar may comprise a tank car and the container may comprise the tank of the tank car.

Some embodiments of the disclosure may provide one or more technical advantages. As an example, particular embodiments may measure the quality or other properties (moisture content, quantity of defects, etc.) of the lading as the lading is loaded, unloaded, in transit, and/or stationary. The intended receiver of the lading (i.e., the end purchaser) may verify that the product is what was expected when ordered. The receiver can determine whether to adjust downstream processing depending on the measurement results. For example, a receiver may make modifications to a grain processing facility based on a moisture content of the received grain in advance of receiving the grain.

Measuring product consistency, quality, and other properties in real time can optimize the efficiency of downstream processing. Advantages may include: measuring product consistency (identifying defects); reducing energy costs by optimizing processing; increasing downstream product quality; reducing downstream resource requirements; increasing productivity and profitability; and reducing waste and time. Detecting sub-par commodities or rejectable commodities after loading or during transport may reduce shipping costs by identifying problems early and circumventing unnecessary shipment. Some embodiments may benefit from some, none, or all of these advantages. Other technical advantages may be readily ascertained by one of ordinary skill in the art.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components.

Although embodiments of the present disclosure and their advantages have been described in detail, it should be understood that various changes, substitutions and alternations can be made herein without departing from the spirit and scope of the invention as defined by the claims below.

1. A railcar, comprising:
a container for transporting a bulk lading;
a sensor operable to determine a characteristic of the bulk lading;
a controller communicably coupled to the sensor and configured to control operation of the sensor; and
a display communicably coupled to the sensor and configured to display a representation of the determined characteristic of the bulk lading.

2. The railcar of claim 1, wherein the sensor is located in an interior portion of the container.

3. The railcar of claim 2, wherein:
the container comprises a discharge gate; and
the sensor is located proximate the discharge gate and is operable to determine the characteristic of the bulk lading as the bulk lading is discharged through the discharge gate.

4. The railcar of claim 2, wherein the sensor is located proximate a top of the container and is operable to determine the characteristic of the bulk lading as the bulk lading is loaded into the container.

5. The railcar of claim 1, wherein the sensor is located on an exterior portion of the container.

6. The railcar of claim 5, wherein:
the container comprises a window; and
the sensor is operable to determine the characteristic of the bulk lading through the window.

7. The railcar of claim 1, wherein the sensor comprises at least one of a near infrared reflectance (NIR) sensor, a radio frequency (RF) sensor, an electrical capacitance (EC) sensor, a camera, a photometer, a charged coupled device, and a laser sensor.

8. The railcar of claim 1, wherein the determined characteristic of the bulk lading comprises a moisture content of the bulk lading.

9. The railcar of claim 1, wherein the determined characteristic of the bulk lading comprises an indication of a foreign substance in the bulk lading.

10. The railcar of claim 9, wherein the foreign substance in the bulk lading comprises mold or fungus.

11. The railcar of claim 1, wherein at least one of the sensor, the controller, and the display comprise a power source.

12. The railcar of claim 1, wherein at least one of the controller and the display are communicably coupled to the sensor wirelessly.

13. A system for determining a characteristic of a bulk lading of a railcar, the system comprising:
a sensor operable to determine a characteristic of a bulk lading;
a controller communicably coupled to the sensor and configured to control sensor operations; and
a display communicably coupled to the sensor and configured to display a representation of the determined characteristic of the bulk lading.

14. The system of claim 13, wherein the sensor is operable to determine the characteristic of the bulk lading as the bulk lading is discharged from the railcar.

15. The system of claim 13, wherein the sensor is operable to determine the characteristic of the bulk lading as the bulk lading is loaded into the railcar.

16. The system of claim 13, wherein the sensor comprises at least one of a near infrared reflectance (NIR) sensor, a radio frequency (RF) sensor, an electrical capacitance (EC) sensor, a camera, a photometer, a charged coupled device, and a laser sensor.

17. The system of claim 13, wherein at least one of the sensor, the controller, and the display comprise a power source.

18. The system of claim 13, wherein at least one of the controller and the display are communicably coupled to the sensor wirelessly.

19. A railcar, comprising:
a container for transporting a bulk lading;
a sensor operable to determine a characteristic of the bulk lading;
a controller communicably coupled to the sensor and configured to control operation of the sensor; and
a memory coupled to the controller, the memory operable to store a result of a measurement performed by the sensor.

20. The railcar of claim 19, the memory comprising a removable storage media.
